(19) United States
(12) Patent Application Publication
(10) Pub. No.: US 2019/0377325 A1
(43) Pub. Date: Dec. 12, 2019

(54) SYSTEM AND METHODS OF NOVELTY DETECTION USING NON-PARAMETRIC MACHINE LEARNING

(71) Applicant: NRG SYSTEMS, INC., Hinesburg, VT (US)

(72) Inventor: Enrique Daniel Angola Abreu, Winooski, VT (US)

(21) Appl. No.: 16/480,148

(22) PCT Filed: Jan. 23, 2018
(86) PCT No.: PCT/US18/14787

§ 371 Date: Jul. 23, 2019

Related U.S. Application Data
(60) Provisional application No. 62/449,268, filed on Jan. 23, 2017.

(51) Int. Cl. G05B 19/4065; G06N 3/08; G06N 3/04; G05B 13/02

(52) U.S. Cl. CPC G05B 19/4065; G06N 3/08; G05B 2219/37337; G05B 13/0265; G06N 3/0472

(57) ABSTRACT

In general, a system and method consistent with the present disclosure allows for non-parametric modeling of audio data by advantageously utilizing a feature space of training vectors that is one-dimensional. A novelty detector consistent with the present disclosure may capture a plurality of audio samples and convert the same into a time-frequency domain pattern to establish a baseline sound signature using a statistical approach. A plurality of monitoring nodes may be associated with one or more frequencies represented within the time-frequency domain pattern. Each node may then compare subsequently captured time-frequency domain patterns to detect values which exceed a so-called “normal” threshold, with the threshold being dynamically derived based on the baseline sound signature in some embodiments. In the event a predetermined number of nodes detect a novelty in the sound signature, alerts may be issued to users/technicians.

### CROSS-REFERENCE TO RELATED APPLICATIONS

The present non-provisional application claims the benefit of U.S. Provisional Patent Application Ser. No. 62/449,268 filed on Jan. 23, 2017, the entire content of which is hereby incorporated by reference.

### TECHNICAL FIELD

The present disclosure generally relates to audio monitoring to detect faults and other conditions, and in particular, to converting audio emitted from machinery to time-frequency patterns and performing statistical analysis on the same to detect the presence of novel audio signals that may indicate a fault or other condition of interest.

### BACKGROUND INFORMATION

In machine learning, novelty detection can be defined as the capability to detect unknown data which is not part of a training set or otherwise exceeds predetermined thresholds. Novelty detection can be useful in mechanical applications where abnormal behavior of machinery could be a symptom of a mechanical failure. Other useful applications for novelty detectors include hand written digit recognition, radar target detection, detection of masses in mammograms, e-commerce, and statistical process control, just to name a few. Statistical novelty detection approaches are based on building a statistical model from a set of training data and estimating if a test sample belongs to the same distribution or not.

There are two basic models to follow when designing a statistical novelty detector: parametric and non-parametric. Parametric methods assume that the data comes from a family of known distributions. On the other hand, non-parametric methods do not make assumptions about the data distribution and instead estimate a distribution based on the data itself. Non-parametric methods tend to be very powerful for problems that require adaptability and those where the underlying distribution is naturally unknown. However, non-parametric methods tend to be more computationally expensive than parametric techniques.

### BRIEF DESCRIPTION OF THE DRAWINGS

These and other features and advantages will be better understood by reading the following detailed description, taken together with the drawings wherein:

FIG. 1 shows an example novelty detection system consistent with embodiments of the present disclosure;

FIG. 2 shows an example time-frequency domain pattern for a baseline audio signal in accordance with an embodiment of the present disclosure.

FIG. 3 shows an example test bench in accordance with an embodiment of the present disclosure.

FIGS. 4A and 4B show an example time domain for a baseline signal and a signal with a novelty, respectively.

FIG. 5 shows an example time-frequency domain pattern for a signal with a digitally-introduced novelty, in accordance with an embodiment of the present disclosure.

FIG. 6 shows estimated kernel densities for the time-frequency domain pattern of FIG. 6, in accordance with an embodiment of the present disclosure.

FIG. 7 shows an example time pattern of frequency bin 40 for the baseline audio signal of FIG. 2 in isolation, in accordance with an embodiment of the present disclosure.

FIG. 8 shows an example probability density function of the energy estimated by the monitoring node associated with frequency bin 40 based on a baseline audio signal.

FIG. 9 shows an example time pattern for frequency bin 40 of the audio signal with a novelty in isolation.

FIG. 10 shows an example probability density function of the energy estimated by the monitoring node associated with frequency bin 40 based on the novelty in the audio signal.

FIG. 11 shows an example time pattern of frequency bin 80 for the baseline audio signal of FIG. 2 in isolation, in accordance with an embodiment of the present disclosure.

FIG. 12 shows an example probability density function of the energy estimated by the monitoring node associated with frequency bin 80 based on the baseline audio signal.

FIG. 13 shows an example time pattern for frequency bin 40 of the audio signal with a novelty.

FIG. 14 shows an example probability density function of the energy estimated by the monitoring node associated with frequency bin 80 based on the novelty in the audio signal.

FIG. 15 shows the results from a trained network of monitoring nodes consistent with the present disclosure when a novelty is introduced.

FIG. 16 shows the results from a trained network of nodes consistent with the present disclosure when an audio signal remains substantially similar to a baseline audio signal.

FIG. 17 shows an example process for detecting novelty in an audio signal, in accordance with an embodiment of the present disclosure.

### DETAILED DESCRIPTION

Condition monitoring systems can be essentially broken down into three different approaches, namely, case-based reasoning, model-based diagnosis, and non-parametric modeling. Case-based reasoning relies on imposed rules, and requires the knowledge and influence of an expert to monitor the machine. Model-based diagnosis requires an often complex, mathematical model of the system. Oftentimes a mathematical model of such complexity might be impractical to achieve in reality.

Non-parametric techniques approach the problem by modeling the system based on learned patterns from training data. A non-parametric model can be created by, for example, the use of neural networks or statistical techniques such as Parzen Window. Such a model can be completely automated, and does not require expert knowledge. However, a drawback of non-parametric modeling is that a large amount of data is required to train the model. With Parzen Windows, the amount of training data needed grows exponentially relative to the dimension of the feature space. This is commonly referred to as the curse of dimensionality. The curse of dimensionality increases the computational expense of a non-parametric novelty detector, as well as potentially causing loss of important information from the data.

In general, a system and method consistent with the present disclosure allows for non-parametric modeling of audio data by advantageously utilizing a feature space of training vectors that is one-dimensional, which eliminates or otherwise reduces constraints associated with other models that are constrained by the curse of dimensionality. A novelty detector consistent with the present disclosure can capture a plurality of audio samples and convert the same into a time-frequency domain pattern to establish a baseline sound signature, e.g., by applying a short windowed Fast-Fourier-Transform. A plurality of monitoring nodes may be associated with one or more frequencies represented within the time-frequency domain pattern. Each node may then compare subsequently captured time-domain patterns to detect novel sound patterns which exceed a so-called “normal” threshold, with the threshold being dynamically derived based on the baseline sound signature. In the event a predetermined number of nodes detect a novelty in the sound signature, alerts may be issued to users/technicians Thus, a novelty detector consistent with the present disclosure may “learn” a sound signature for machinery without a priori knowledge and dynamically establish novelty thresholds to detect conditions that may be of interest to a user. Moreover, the nodes operate with a training vector of a single dimension thus reducing the computational complexity that limits other approaches to parametric modeling.

As generally referred to herein, a training vector is used to refer to training data that may be utilized when training, for example, a kernel density estimation algorithm. In the present disclosure, the training vector may be one-dimensional (1-D) and thus may be understood as a “single feature” in machine learning terms. As discussed in greater detail below, a plurality of such training vectors may be used to learn a probability distribution function (PDF) of a baseline signal. A training step/stage may then occur after raw audio samples are converted into a time-frequency domain pattern. Therefore, a single training vector may be correctly understood as a data point at a specific time and frequency. This data may thus represent the amplitude of the baseline signal at a specific moment of time for a specific frequency bin.

As generally referred to herein, the terms “novelty” or “novel sound condition” may be interchangeably used to refer to a change in a sound signature relative to a baseline sound signature that may be indicative of a condition of interest. Some such conditions of interest may be a mechanical fault (or an indication of an impending mechanical fault) that may affect machinery performance, although this disclosure is not limited to condition monitoring of machinery. Thus, “novelty” refers to audio samples which include novel sound patterns at one or more frequencies that exceed a predetermined threshold, e.g., outside of established “norms.” One illustrative, non-limiting example includes a sudden metal clanging caused by a mechanical fault. In such a case, the novelty is the sound pattern detected at various frequencies as a result of the mechanical fault.

Although the scenarios and examples discussed herein specifically reference monitoring of machinery for novel sound conditions, this disclosure is not limited in this regard. Any noise-producing machine/object capable of generating vibrations through air or another medium may be monitored to detect novelties. Some non-limiting examples include engines (e.g., electrical, diesel, and so on), robotic manufacturing equipment, generators, air conditioning equipment, refrigeration equipment, people and animals.

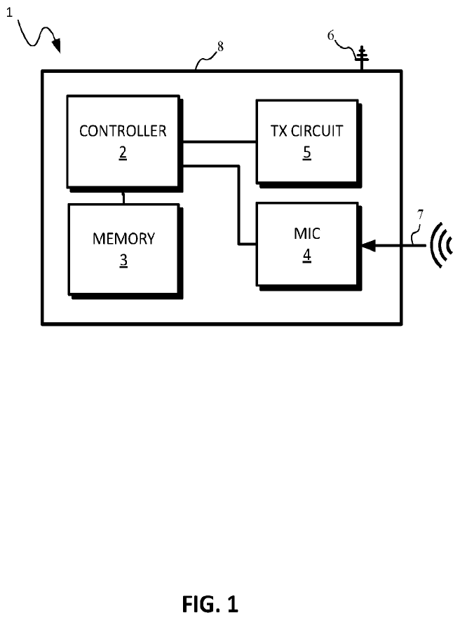

Now turning to the Figures, FIG. 1 shows an example novelty detection system 1 consistent with embodiments of the present disclosure. The novelty detection system 1 is shown in a highly simplified form and other embodiments are within the scope of this disclosure.

As shown, the novelty detection system includes a controller 2, a memory 3, a microphone device 4, a transmit (TX) circuit 5, an antenna 6, and a housing 8. Note while the novelty detection system 1 is depicted as a single system disposed within a single housing, e.g., housing 8, this disclosure is not necessarily limited in this regard. For instance, in some embodiments a microphone may capture audio samples and deliver the same via a network, e.g., the Internet, to a remote computer system, such as a computer server, workstation, or mobile computing device, which may then perform novelty detection processes as variously disclosed herein.

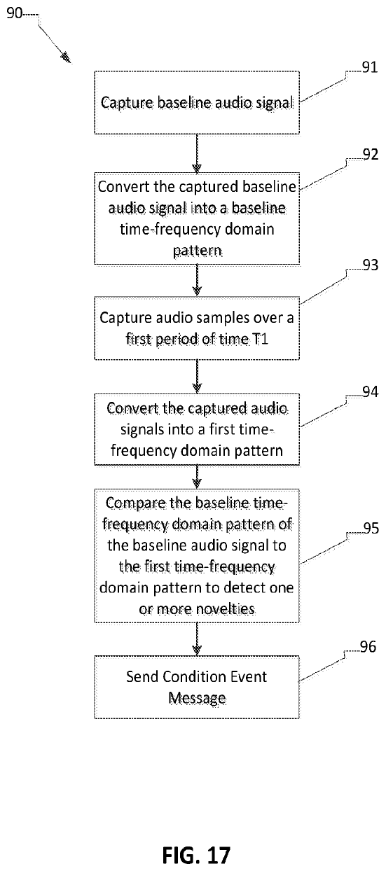

Continuing on, the controller 2 comprises at least one processing device/circuit such as, for example, a digital signal processor (DSP), a field-programmable gate array (FPGA), Reduced Instruction Set Computer (RISC) processor, x86 instruction set processor, microcontroller, an application-specific integrated circuit (ASIC). The controller 2 may comprise a single chip, or multiple separate chips/circuitry. As discussed further below, the controller 2 may implement a novelty detection process using software (e.g., C or C++ executing on the controller/processor 2), hardware (e.g., circuitry, hardcoded gate level logic or purpose-built silicon) or firmware (e.g., embedded routines executing on a microcontroller), or any combination thereof. In one embodiment, the controller 2 may be configured to carry out the processes 90 of FIG. 17.

The memory 3 may comprise volatile and/or non-volatile memory devices. In an embodiment, the memory 3 may include a relational database, flat file, or other data storage area for storing a baseline/reference time-frequency domain pattern (or audio samples that may be used to generate a baseline/reference time-frequency domain pattern) that may be used when performing novelty detection as disclosed herein.

The microphone device may comprise one or more microphones. The one or more microphones may comprise at least one of a unidirectional and/or omnidirectional microphone device. The microphone device 4 may be configured to detect/capture audio samples 7. The microphone device 4 may include associated conversion circuitry to convert audio data 7 to digital audio samples and provide the same as output to the controller.

The TX circuit 5 may comprise a network interface circuit (NIC) for communication via a network, e.g., the Internet. In cases where the TX circuit 5 communicates wirelessly, the antenna device 6 may be utilized. The novelty detection system 1 may be configured for close range or long range communication between the carcass detection system 1 and remote computing devices.

The term, “close range communication” is used herein to refer to systems and methods for sending/receiving data signals between devices that are relatively close to one another (e.g., either wirelessly or via wired connection). Close range communication includes, for example, communication between devices using a BLUETOOTH™ network, a personal area network (PAN), near field communication, ZigBee networks, millimeter wave communication, ultra-high frequency (UHF) communication, combinations thereof, and the like. Close range communication may therefore be understood as enabling direct communication between devices, without the need for intervening hardware/systems such as routers, cell towers, internet service providers, and the like.

In contrast, the term, “long range communication” is used herein to refer to systems and methods for sending/receiving data signals between devices that are a significant distance away from one another. Long range communication includes, for example, communication between devices using WiFi, a wide area network (WAN) (including but not limited to a cell phone network, the Internet, a global positioning system (GPS), a whitespace network such as an IEEE 802.22 WRAN, combinations thereof and the like. Long range communication may therefore be understood as enabling communication between devices through the use of intervening hardware/systems such as routers, cell towers, whitespace towers, internet service providers, combinations thereof, and the like.

The housing 8 may be ruggedized and sealed to prevent ingress of contaminants such as dust and moisture. In some specific example cases, the housing 8 may comport with standards for ingress protection (IP) and have an IP67 rating for the housing 8 and associated cables and connectors (not shown) as defined within ANSI/IEC 60529 Ed. 2.1b, although other IPXY ratings are within the scope of this disclosure with the X denoting protection from solids and Y denoting protection from liquids. In some cases, the housing 8 comprises a plastic, polycarbonate, or any other suitably rigid material.

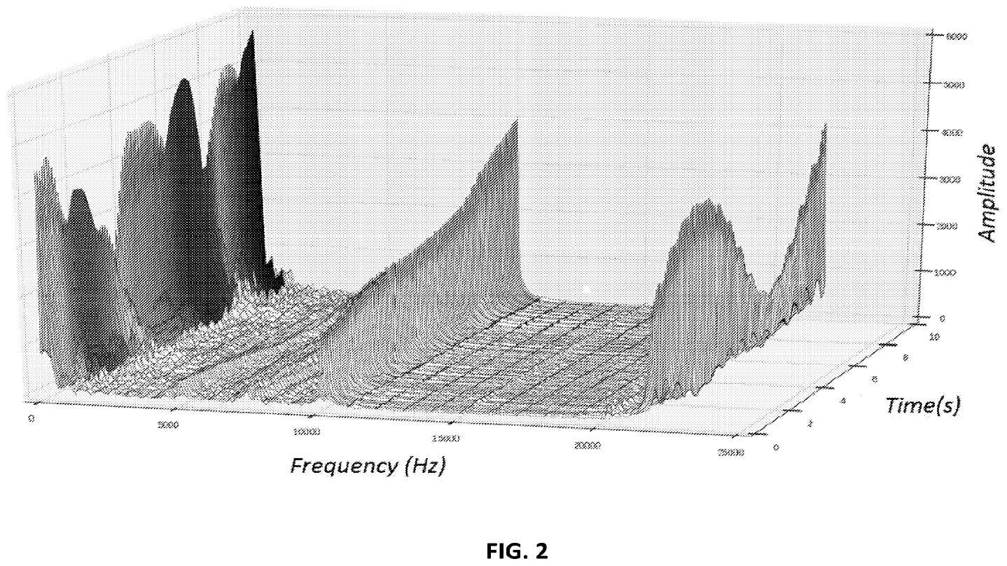

In operation, the controller 2 may receive the captured audio samples 7 and convert the same into a time-frequency domain pattern using an audio preprocessing routine. In an embodiment, the controller 2 may apply a short windowed Fast-Fourier-Transform (short-time FFT) to the captured audio samples 7 to generate the time-frequency domain pattern, although other transformations are within the scope of this disclosure. For instance, discrete wavelet transform may be utilized to generate a time-frequency domain pattern. In any event, one such example time-frequency domain pattern is shown in FIG. 2, whereby a target frequency range, e.g., 0 to 25 KHz, is plotted relative to time T.

Some aspects of the time-frequency domain pattern may better understood by way of example. When listening to rotating machinery, such as a running automobile, the human ear and brain can detect frequency variations over time. This is due to the non-stationary nature of audio signals. Sound waves are composed of packets of close frequencies rather than pure tones. The Windowed Fourier Transform offers the capability of local time-frequency decomposition, which retrieves instantaneous packets of frequencies from sound when applied to the time-domain signal.

In an embodiment, the short-time Fourier Transform for a signal f may thus be defined by the following equation:

Sf(u,ξ)=∫_{-∞}^{∞}f(t)g(t−u)e^{-iξt}dt Equation (1)

where g(t) is a real and symmetric window, translated by u and modulated by the frequency ξ.

The discretization of the short-time Fourier Transform leads to the short-time Fast Fourier Transform:

$$Sf [ m , l ] = {\sum }_{n = 0}^{N - 1} f [ n ] g [ n - m ] exp ( \frac{- i 2 π l n}{N} ) \qquad Equation ( 2 )$$

where N is the period of the signal f, and m is the translation in n for the window g (n). It follows that for each 0≤m<N, Sf[m, l] is calculated for 0≤l<N with a discrete Fourier Transform of f[n]g[n−m]. This is performed with N FFT procedures of size N, and thus uses a total of O(N² log₂ N) operations.

Continuing on, the controller 2 may associate one or more frequencies within the time-frequency domain pattern with a frequency bin. A monitoring node may then be assigned to one or more frequency bins in the time-frequency domain. For example, at a sampling rate of 44100 Hz and a time window of 10 ms for the short-time FFT, there may be a total of 220 frequency bins. Each monitoring node may monitor one or more of those frequency bins. Other sampling rates may be utilized and are within the scope of this disclosure.

Each monitoring node may be dedicated hardware (e.g., an ASIC, or a separate chip) and/or software implemented by the controller 2. Each monitoring node may then statistically model the probability density function (PDF) of the time-domain pattern for a respective frequency bin. In an embodiment, this is accomplished by assigning a Parzen Window to each frequency bin. This may be advantageously utilized to provide a non-parametric, adaptive, statistical approach for novelty detection purposes. In addition, each node may operate in parallel during detection processes. Thus, in a general sense, the nodes may operate similar to that of hair filaments in the inner ear of a human to provide time-frequency information signals to the brain.

A Parzen Window is a non-parametric technique to estimate the probability density P(x) from which the sample x was derived. The probability density estimates for each frequency bin using dependently and identically distributed samples x, . . . , xₙ can be defined by the following equation:

$${p}_{n} ( x ) = \frac{1}{n} {\sum }_{i = 1}^{n} \frac{1}{{V}_{n}} ψ ( \frac{x - {x}_{i}}{{h}_{n}} ) \qquad Equation ( 3 )$$

where Vₙ=hₙ^{d}, h is the bandwidth parameter, and ψ is the kernel function (e.g., Gaussian) in the d-dimensional space.

The generated time-frequency domain pattern may then be compared to a model (or baseline signature) to identify changes relative to normal patterns for each frequency bin. Training of the nodes may include capturing of audio samples by the microphone device 4 representing sound emitted by adjacent machinery during so-called “normal” or “healthy” periods (e.g., during periods without a mechanical fault/condition). The captured audio samples may then be digitized and stored in the memory as a baseline signal/signature. The baseline signal may be stored as a time-frequency domain pattern, as discussed above, or may be stored as a raw audio samples (e.g., as captured). In either case, the controller 2 may then assign a Parzen Window to each node j, with the Parzen Window being used to estimate density for captured audio samples.

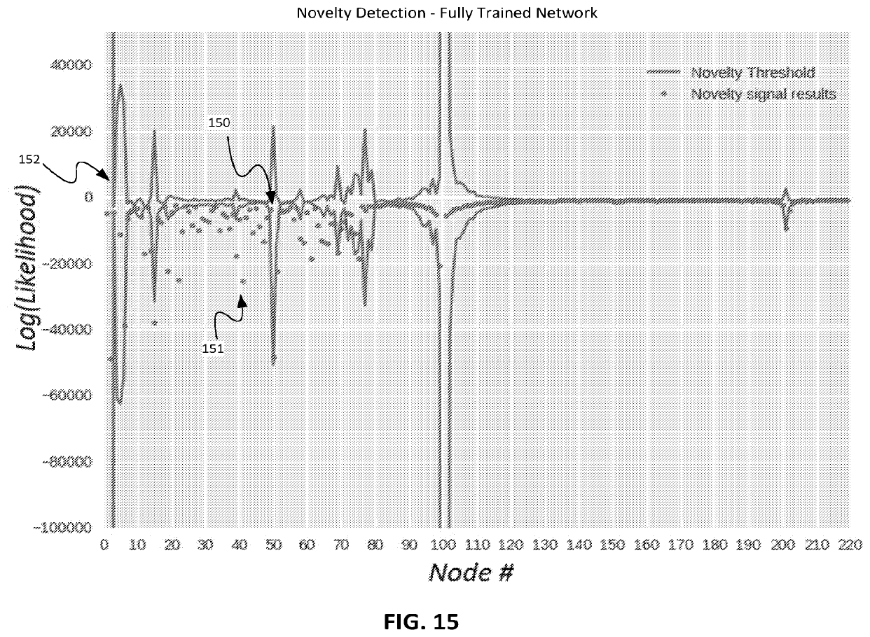

A novelty threshold for each node may be determined by capturing a predetermined number of audio samples (Xᵢ) for machinery in the ‘normal’ state, where i is the sample number. The novelty threshold may be a minimum and maximum limit that may collectively form a “normal” or “healthy” operating region (See FIG. 15). For each audio sample, the log-likelihood Yᵢⱼ for each node can then be estimated from the trained Parzen Windows. The threshold t for each j may be found by setting an outlier limit using the following equation:

tⱼ=μⱼ±k*σⱼ Equation (4)

where μⱼ is the mean of the given set {Y₁ⱼ, Y₂ⱼ, . . . Yₙⱼ}, σⱼ the standard deviation of the set, and k is a constant, e.g., 3 or other suitable value.

Once trained, monitoring nodes may monitor new audio signals coming from the machinery and can calculate likelihood of a novel event by comparison of a PDFs of the new audio signal relative to the PDFs of the baseline signature. In an embodiment, each node may detect if a new audio signal exceeds a corresponding novelty threshold, and in response thereto, may cause an alert to be presented to a user. The user alert may comprise one or more of a graphical user interface (GUI) message box, a short message service (SMS) text, an audible alert (e.g., a beep, a bell, a siren, or other sound to indicate the presence of a novelty), and/or a push notification sent to an “app” executed on a smartphone or other mobile computing device.

As discussed in greater detail below, monitoring nodes may operate in parallel and output number representing the likelihood that a new pattern fits the distribution of the training set, e.g., the baseline signal. In an embodiment, no communication occurs between nodes and each operates independent from the others for detection and reporting purposes.

In other exemplary embodiments, inter-node communication may be utilized to provide a network of nodes that share information for classification purposes. For example, some types of mechanical faults can cause more than one monitoring node to detect a novel event due to the harmonics or different phenomena by which a particular condition releases energy. Therefore, nodes may exchange information and may be used to model the entire frequency-time domain pattern, or at least a portion thereof. By way of example, consider how a human recognizes a voice belonging to a specific person. Each voice is composed of numerous sound patterns, but is recognizable and distinguishable from other voices.

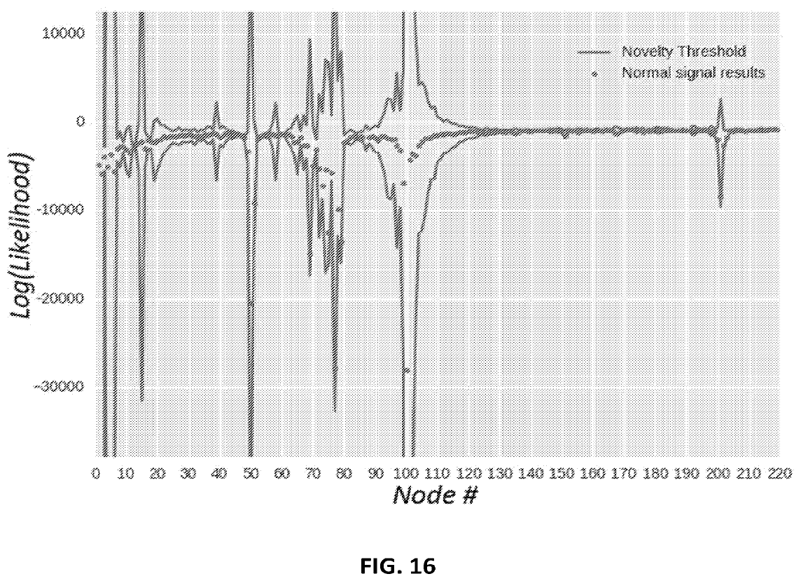

Therefore, information may be shared between two or more monitoring nodes to detect a novelty event and raise an alarm to a user. In particular, two or more nodes may communicate in a neural network fashion to collectively provide classification for detected novelty events. In some cases, this may include utilizing results output by a novelty detector consistent with the present disclosure, e.g., see FIG. 15, and applying a supervised or unsupervised learning algorithm to learn an associated pattern. In some cases, a Boltzman machine could utilize and learn from such output. For instance, comparing the dots of FIG. 15 and FIG. 16, it is evident that they represent different sound signatures relative to a baseline signal and these discernable differences may be exploited for classification purposes.

Another example approach to classification may include having the classification stage at a relatively low level. Such low-level classification may include implementing a classification algorithm at each node, such as a probabilistic neural network (PNN). In this example, classification happens per node and the results from each node may be summed to obtain a final classification result.

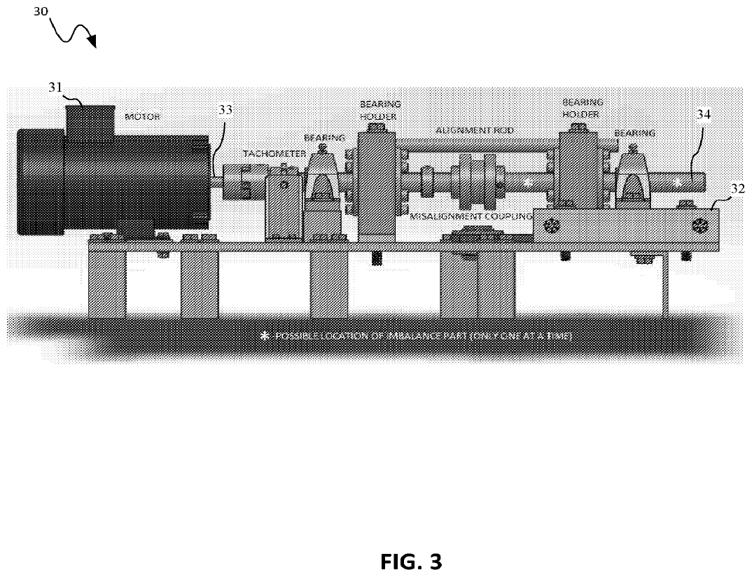

Continuing on, a test-bench was constructed as shown in FIG. 3 to simulate various machinery conditions that may present varying audio signatures/patterns. Experiments were performed to validate novelty detection processes disclosed herein, but are not intended to be limiting. As shown, the test-bench 30 includes an electric motor 31 capable of producing consistent torque from 100-3600 RPM. The electric motor is coupled to a free-spinning shaft 33 supported by two bearings, which are coupled with a second shaft 34 through a rubber coupling mechanism and also supported by two bearings. The rubber coupling mechanism allows testing for shaft misalignment by shifting the base-plate 32 supporting the second shaft. A second internally damaged motor (not shown) was also used for purposes of simulation. The second motor's internal shaft was slightly misaligned, which caused damaging friction between internal components.

For the following discussion of experimental results, audio samples were collected for 10 seconds at a sample rate of 44100 Hz from a 2.7 Hz rotating shaft. In addition, audio samples for 10 seconds (e.g., without an error condition) at the same rate was captured for purposes of establishing a baseline.

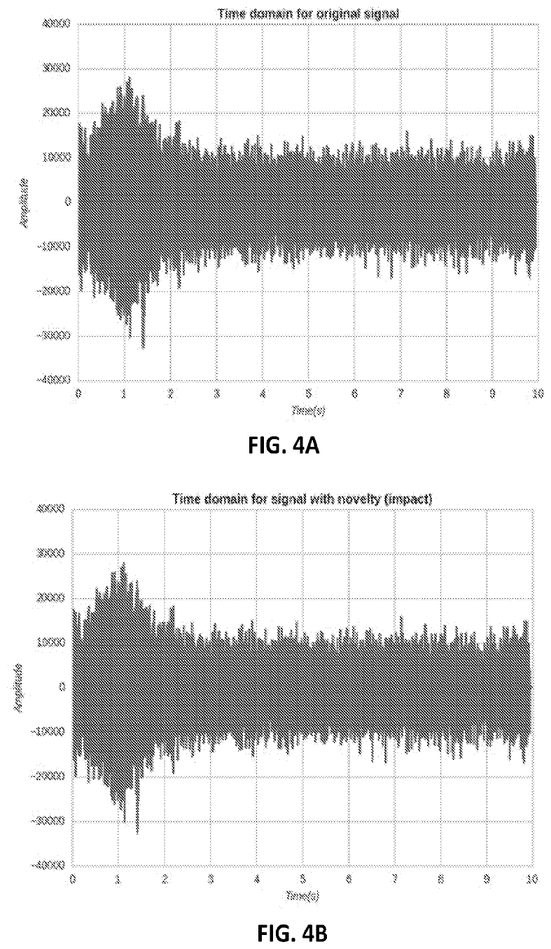

A first synthetic novelty event was introduced in the form of an impulse signal, modulated by 0.2 Hz, with a carrier frequency of 4 KHz. The impulse signal was digitally introduced to an audio signal to induce novelty. Lower energy 2^{nd} (8 KHz) and 3^{rd} (12 KHz) harmonics were also introduced. FIG. 4A depicts a 0.01 s sample (starting from time=0) from the raw time domain signal before the synthetic novelty was introduced. FIG. 4B shows a 0.01 s sample (starting from time=0) from the raw time domain signal after the synthetic novelty was introduced.

As shown by each of the signals in the time domain, raw audio from rotating machinery can be noisy and chaotic in nature. The differences between FIGS. 4A and 4B are imperceptible to the naked eye. However, it is known from the introduction of the synthetic novelty that a 0.01 s sample of the novel signal should contain novel energy. The nature of the signals represented by FIGS. 4A and 4B demonstrate that pre-processing may be utilized to obtain a “cleaner” pattern and time-frequency information. The extreme similarities between both signals were chosen simply to more easily explain the process of novelty detection as disclosed herein and to show the capabilities thereof in detecting relatively minute novelties.

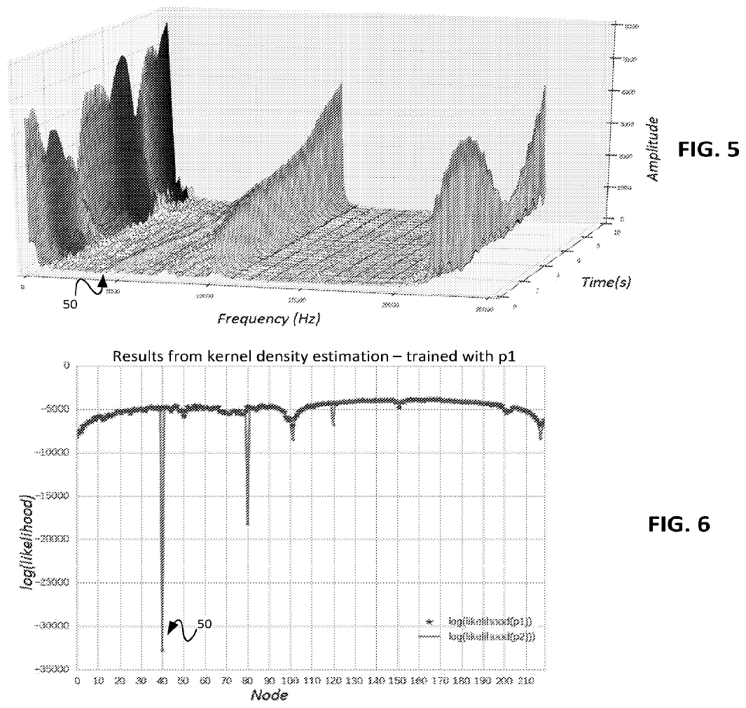

After the raw signals were processed with short-time FFT, e.g., using Equations (1) and (2), the time-frequency pattern shown in FIG. 2 was generated based on the baseline audio signal. FIG. 5 shows the time-frequency domain pattern after introduction of the synthetic novelty. As can be seen, the patterns shown in FIGS. 2 and 5 are substantially clearer than that of the time domain signals shown in FIGS. 4A and 4B. However, the novel energy pattern is difficult to detect by visual observation of FIG. 5. This is because of the relatively low energy of the novelty compared to the rest of the pattern. However, a close examination of frequency bins 40, 80, and 120 show a novel pattern. Note, for a sampling rate of 44100 Hz and a time window of 10 ms for the short-time FFT, there are a total of 220 frequency bins. For instance, frequency bin 40 generally indicated at 50 includes energy from frequencies 4000 Hz-5000 Hz and includes a novel pattern.

FIG. 6 shows results obtained from each monitoring node for the period of time represented by the time-frequency domain pattern of FIG. 5. In particular, FIG. 6 plots kernel density estimates for each of the frequency bins 1 to 220, and importantly, the PDF of the synthetic novelty signal at frequency bins 40 and 80, e.g., 4000 Hz and 8000 Hz, respectively. In this plot, p1 is a first pattern representing the baseline signal and p2 represents a second signal with the synthetic novelty. As shown, frequency bins 40 and 80 depict the presence of the novelty. In contrast, the monitoring node for the third harmonic, i.e., frequency bin=120, also shows differences, but not as high relative to the other observed novelties. This is due to the relatively low energy of the synthetic novelty signal at 12 KHz.

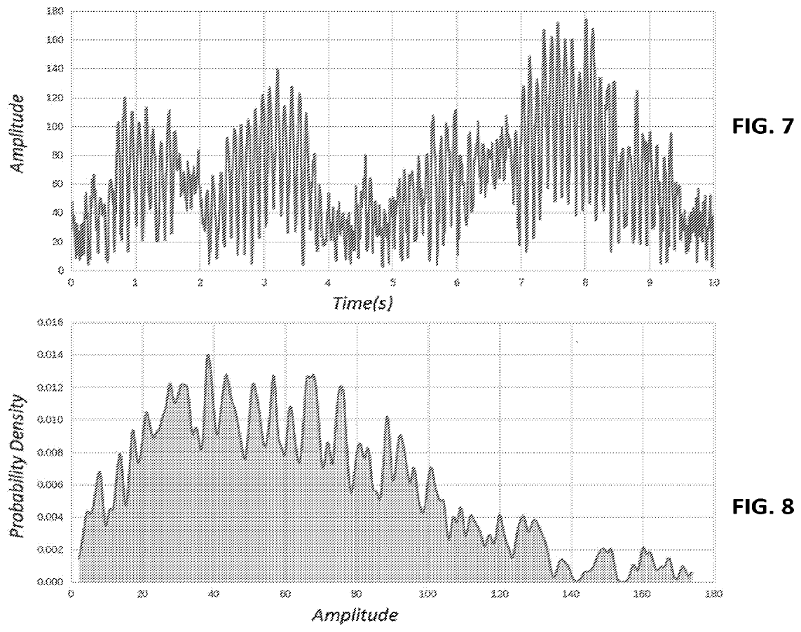

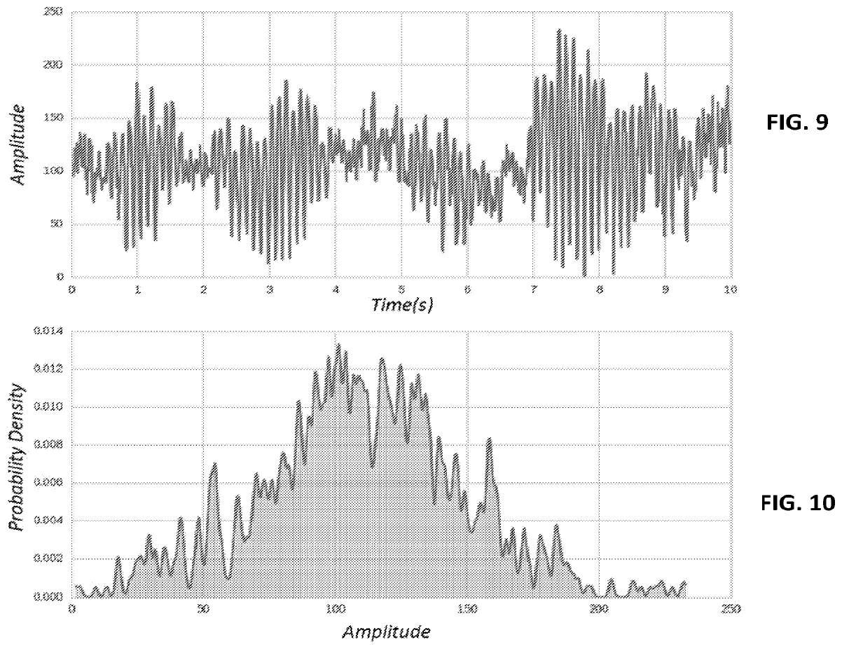

FIG. 7 shows the time pattern at frequency bin 40 in isolation for the baseline audio signal of FIG. 2. FIG. 8 shows the PDF of the energy estimated by the monitoring node associated with the frequency bin 40 of FIG. 7. In contrast, FIG. 9 illustrates the time pattern at frequency bin 40 for the synthetic novelty signal, and its respective PDF estimated by the associated monitoring node is shown in FIG. 10. As shown, the PDFs of FIGS. 8 and 10 are substantially different and can allow a monitoring node to detect the occurrence of a novelty in the captured audio.

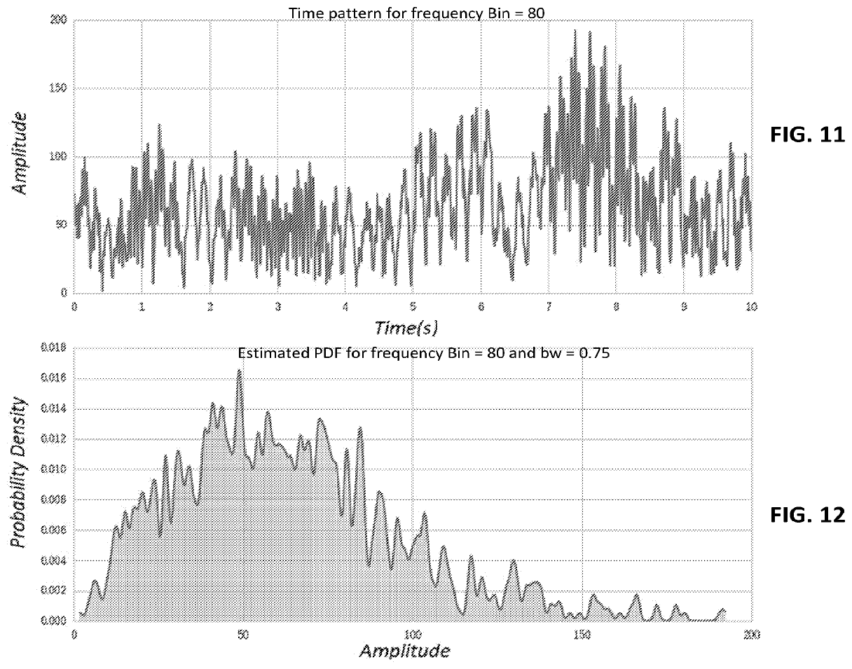

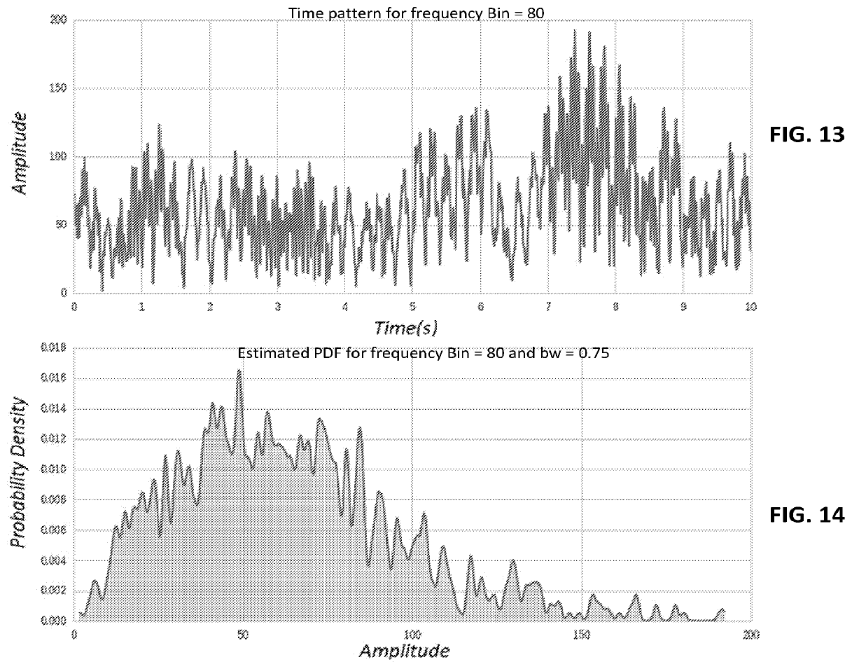

FIG. 11 shows the time pattern at frequency bin 80 in isolation for the baseline audio signal. FIG. 12 shows the PDF of the energy estimated by the monitoring node associated with the frequency bin 80. In contrast, FIG. 13 illustrates the time pattern at frequency bin 80 for the synthetic novelty signal and, its respective PDF estimated by the associated monitoring node is shown in FIG. 14. Similar to FIGS. 7-10 discussed above, the PDFs for frequency bin 80 before and after introduction of the novelty are markedly different.

Additional experiments were performed to train monitoring nodes and determine suitability for a range of audio signals/changes. One particular example experiment included using the test bench of FIG. 3 with the shaft rotating at 2.7 Hz. Seven independent audio samples at a 44100 Hz sampling rate were collected. A novelty detector consistent with the present disclosure was then trained via the first sample which was used as a baseline audio signal, e.g., audio generated by the test bench without a fault condition introduced. Then the six additional samples were used for establishing the novelty threshold as discussed above. An 8^{t}h novel audio sample with an introduced random novelty was then collected. The novelty was introduced by randomly tapping a metallic element of the machine with a small wrench three times over a period of 10 seconds. This was done to simulate a small metallic piece randomly impacting a component of the machine.

FIG. 15 depicts the results obtained from this experiment. The novelty threshold 152 is represented by solid lines and collectively form a “healthy” region 150 therebetween with novelties occurring outside of that region. As discussed above, this novelty threshold may be dynamically established via Equation (4). The dotted lines represent results obtained from the trained nodes when presented with the novelty signal. The dots located inside the healthy region 150 indicate where in the frequency domain normal signals (e.g., within the novelty threshold) were detected. On the other hand, the dots 151 located outside the healthy region indicate where in the frequency domain novelties were detected by corresponding nodes. For the particular results shown in FIG. 15, a total of 63 nodes out of 220 nodes detected novel signals.

The total number of monitoring nodes reporting values in FIG. 15 that exceed the novelty threshold relative to the baseline signal indicate a clear departure from “normal.” The ratio of the number of nodes detecting a novelty to nodes detecting normal values may be utilized to predict/indicate the severity of a possible mechanical fault/condition. The ratio may also be used to determine a confidence score for the presence of a novel pattern, with the larger score indicating an obvious and more potentially severe condition. For instance if 20% of nodes, e.g., a ratio of 1:5, may prompt a warning of a relatively minor fault. On the other hand, if greater than or equal to 50% of nodes indicate a fault, e.g., >1:2, then the fault may be considered severe and an elevated alert message may be sent to a user. Other ratios are within the scope of this disclosure and the provided examples are not intended to be limiting.

Monitoring of the detected novelty over time may occur to determine a delta relative to the baseline signal. For instance, if monitoring node results continue to stray further from baseline, it may be an indication that the machine's sound signature has permanently changed. Thus, deltas/changes over time, or lack thereof, may be utilized to determine if the change should establish a new baseline, for instance. Otherwise, if the signal returns to baseline and the novelty is not detected again, it may be likely that the captured novelty is a transient sound and not a permanent change, such as novelties caused by a benign factor such as rain or people talking near equipment. To this end, audio capturing may occur for relatively long periods of time, e.g., minutes, hours, etc., to rule out false positives that may otherwise cause alerts. Additional experiments were performed using the test-bench with the shaft misaligned, and with the damaged motor. In these cases, 139 nodes raised novelties for the former, and 106 novelties were raised for the latter.

FIG. 16 shows results obtained from a novelty detector consistent with the present disclosure when presented with a normal or “healthy” signal. As shown, it is clear how the relative computed likelihoods remain inside the healthy operating region. In this specific case, a total of 0 nodes detected novelties.

FIG. 17 is a flow chart illustrating one exemplary embodiment 90 of a detection process that may be performed by a novelty detection system consistent with the present disclosure. Exemplary details of the operations shown in FIG. 17 are discussed above. In act 91, a baseline audio signal is captured. The baseline audio signal may comprise a plurality of audio samples captured over a period of time, e.g., 10 seconds. In an embodiment, capturing of the baseline audio signal may occur N number of intervals of equal length to average/normalize the baseline audio signal. In act 92, the captured baseline audio signal may be converted into a baseline time-frequency domain pattern and stored in a memory. Note, the baseline audio signal may be stored in the memory in a “raw” fashion and not necessarily converted before being stored in the memory.

In act 93, audio samples may be captured over a first period of time T1. The captured audio samples may then be converted 94 into a first time-frequency domain pattern. In act 95, the baseline time-frequency domain pattern may be compared to the first time-frequency domain pattern. In an embodiment, a plurality of monitoring nodes may each be associated with one or more frequency bins. Each monitoring mode then may compare a PDF of the baseline audio signal for their respective bin(s) to a corresponding PDF in the first time-frequency domain pattern.

In act 96, one or more monitoring nodes my detect a novelty and output a condition event message. In an embodiment, each monitoring node may independently report values to a user outside of the normal/healthy region defined by the novelty threshold for each frequency bin (see FIG. 16). In some cases, the controller 2 may receive output from the monitoring nodes as an input. The controller may then determine whether a threshold number of monitoring nodes are reporting a novelty, e.g., greater than 10, 20, 50% of monitoring nodes reporting a novel event. In response to the controller 2 determining the number of monitoring nodes reporting a novel event exceeds the predetermined threshold, the controller 2 may then send a condition event message to a user.

In accordance with an aspect, a monitoring system for detection of novel audio events is disclosed. The monitoring system comprising a memory, a controller coupled to the memory, the controller to receive a plurality of captured audio samples corresponding to a first period of time T1, convert the plurality of captured audio samples into a time-frequency domain pattern for a predetermined frequency range, the time-frequency domain pattern comprising a plurality of frequency bins and associated amplitude values for frequencies within the predetermined frequency range over the first period of time T1, compare the time-frequency domain pattern to a baseline time-frequency domain pattern to identify a novel condition based in part on at least one frequency bin having a density estimate that exceeds an associated predefined threshold, and send a condition event message with an identifier of the novel condition to a user.

In accordance with another aspect of the present disclosure a computer-implemented method for detecting novelties in an audio signal is disclosed. The method comprising receiving, by a controller, a plurality of captured audio samples corresponding to a first period of time T1, converting, by the controller, the plurality of captured audio samples into a time-frequency domain pattern for a predetermined frequency range, the time-frequency domain pattern comprising a plurality of frequency bins and associated amplitude values for frequencies within the predetermined frequency range over the first period of time T1, comparing the time-frequency domain pattern to a baseline time-frequency domain pattern to identify a novel condition based in part on at least one frequency bin having a density estimate that exceeds an associated predefined threshold, and sending a condition event message with an identifier of the novel condition to a user.

Embodiments of the methods described herein may be implemented using a processor and/or other programmable device. To that end, the methods described herein may be implemented on a tangible, computer readable storage medium having instructions stored thereon that when executed by one or more processors perform the methods. Thus, for example, the transmitter and/or receiver may include a storage medium (not shown) to store instructions (in, for example, firmware or software) to perform the operations described herein. The storage medium may include any type of non-transitory tangible medium, for example, any type of disk including floppy disks, optical disks, compact disk read-only memories (CD-ROMs), compact disk re-writables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of media suitable for storing electronic instructions.

Block diagrams herein represent conceptual views of illustrative circuitry embodying the principles of the disclosure. Similarly, it will be appreciated that any flow charts, flow diagrams, state transition diagrams, pseudocode, and the like represent various processes which may be substantially represented in computer readable medium and so executed by a computer or processor, whether or not such computer or processor is explicitly shown. Software modules, or simply modules which are implied to be software, may be represented herein as any combination of flowchart elements or other elements indicating performance of process steps and/or textual description. Such modules may be executed by hardware that is expressly or implicitly shown.

The functions of the various elements shown in the figures, including any functional blocks, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

As used in any embodiment herein, “circuit” or “circuitry” may comprise, for example, singly or in any combination, hardwired circuitry, programmable circuitry, state machine circuitry, and/or firmware that stores instructions executed by programmable circuitry. In at least one embodiment, the transmitter and receiver may comprise one or more integrated circuits. An “integrated circuit” may be a digital, analog or mixed-signal semiconductor device and/or microelectronic device, such as, for example, but not limited to, a semiconductor integrated circuit chip. The term “coupled” as used herein refers to any connection, coupling, link or the like by which signals carried by one system element are imparted to the “coupled” element. Such “coupled” devices, or signals and devices, are not necessarily directly connected to one another and may be separated by intermediate components or devices that may manipulate or modify such signals. As used herein, use of the term “nominal” or “nominally” when referring to an amount means a designated or theoretical amount that may vary from the actual amount.

Throughout the entirety of the present disclosure, use of the articles “a” and/or “an” and/or “the” to modify a noun may be understood to be used for convenience and to include one, or more than one, of the modified noun, unless otherwise specifically stated. The terms “comprising”, “including” and “having” are intended to be inclusive and mean that there may be additional elements other than the listed elements. As used herein, use of the term “nominal” or “nominally” when referring to an amount means a designated or theoretical amount that may vary from the actual amount.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Also features of any embodiment described herein may be combined or substituted for features of any other embodiment described herein.

While the principles of the disclosure have been described herein, it is to be understood by those skilled in the art that this description is made only by way of example and not as a limitation as to the scope of the disclosure. Other embodiments are contemplated within the scope of the present disclosure in addition to the embodiments shown and described herein. Modifications and substitutions by one of ordinary skill in the art are considered to be within the scope of the present disclosure, which is not to be limited except by the following claims.

What is claimed is:

1. A monitoring system for detection of novel audio events, the monitoring system comprising:
a memory;
a controller coupled to the memory, the controller to:
receive a plurality of captured audio samples corresponding to a first period of time T1;
convert the plurality of captured audio samples into a time-frequency domain pattern for a predetermined frequency range, the time-frequency domain pattern comprising a plurality of frequency bins and associated amplitude values for frequencies within the predetermined frequency range over the first period of time T1;
compare the time-frequency domain pattern to a baseline time-frequency domain pattern to identify a novel condition based in part on at least one frequency bin having a density estimate that exceeds an associated predefined threshold; and
send a condition event message with an identifier of the novel condition to a user.

2. The monitoring system of claim 1, wherein converting the plurality of captured audio samples into the time-frequency domain pattern includes applying a short windowed Fast-Fourier-Transform (short-time FFT) to the plurality of captured audio samples.

3. The monitoring system of claim 1, wherein comparing the time-frequency domain pattern to the baseline time-frequency pattern includes applying a first Parzen Window to audio samples associated with the at least one first frequency bin to derive a probability density function (PDF).

4. The monitoring system of claim 3, wherein the Parzen Window is given by the following equation:
$${p}_{n} ( x ) = \frac{1}{n} {\sum }_{i = 1}^{n} \frac{1}{{V}_{n}} ψ ( \frac{x - xi}{{h}_{n}}$$
where Vₙ=hₙ^{d}, h is a bandwidth parameter, and ψ is a kernel function in the d-dimensional space.

5. The monitoring system of claim 3, wherein the derived PDF is used to determine a log-likelihood value, and wherein in response to the log-likelihood value exceeding the associated predefined threshold, the controller sends the condition event message with an identifier of the novel condition to a user.

6. The monitoring system of claim 1, the controller further configured to:
receive a plurality of baseline audio samples corresponding to a second period of time T2, the second period of time T2 being prior to the first period of time T1;
convert the plurality of baseline audio samples into a time-frequency domain pattern; and
store the time-frequency domain pattern as the baseline time-frequency domain pattern in the memory.

7. The monitoring system of claim 1, wherein the predefined threshold for the at least one frequency bin is derived based on an outlier limit applied to corresponding audio samples represented within the baseline time-frequency domain pattern.

8. A computer-implemented method for detecting novelties in an audio signal, the method comprising:
receiving, by a controller, a plurality of captured audio samples corresponding to a first period of time T1;
converting, by the controller, the plurality of captured audio samples into a time-frequency domain pattern for a predetermined frequency range, the time-frequency domain pattern comprising a plurality of frequency bins and associated amplitude values for frequencies within the predetermined frequency range over the first period of time T1;
comparing the time-frequency domain pattern to a baseline time-frequency domain pattern to identify a novel condition based in part on at least one frequency bin having a density estimate that exceeds an associated predefined threshold; and
sending a condition event message with an identifier of the novel condition to a user.

9. The computer-implemented method of claim 8, wherein converting, by the controller, the plurality of captured audio samples into the time-frequency domain pattern includes applying a short windowed Fast-Fourier-Transform (short-time FFT) to the plurality of captured audio samples.

10. The computer-implemented method of claim 8, further comprising associating each of the frequency bins with a respective monitoring node.

11. The computer-implemented method of claim 10, wherein comparing the time-frequency domain pattern to a baseline time-frequency domain pattern further comprises each monitoring node applying a Parzen Window to each associated audio sample to derive a probability distribution function (PDF), and wherein identifying novelty includes comparing the derived PDF to a corresponding PDF of the baseline time-frequency domain pattern.

12. The computer-implemented method of claim 11, wherein the Parzen Window is given by the following equation:
$${p}_{n} ( x ) = \frac{1}{n} {\sum }_{i = 1}^{n} \frac{1}{{V}_{n}} ψ ( \frac{x - {x}_{i}}{{h}_{n}}$$
where Vₙ=hₙ^{d}, h is a bandwidth parameter, and ψ is a kernel function in the d-dimensional space.

13. The computer-implemented method of claim 11, wherein the derived PDF is used to determine a log a log-likelihood value, and wherein in response to the log-likelihood value exceeding the associated predefined threshold, the method further comprises sending the condition event message with an identifier of the novel condition to a user.

14. The computer-implemented method of claim 8, further comprising generating the baseline time-frequency domain pattern by capturing a plurality of audio samples when machinery is operating in a normal condition.

15. The computer-implemented method of claim 8, wherein generating the baseline time-frequency domain pattern further comprises capturing audio samples for a plurality of equal-length intervals.
